(19) United States
(12) Patent Application Publication
(10) Pub. No.: US 2013/0177192 A1
(43) Pub. Date: Jul. 11, 2013

(54) Vented Microphone Module

(71) Applicant: KNOWLES ELECTRONICS, LLC, Itasca, IL (US)

(72) Inventors: Michael J. Abry, Kildeer, IL (US); Matthew Manley, Crystal Lake, IL (US)

(73) Assignee: KNOWLES ELECTRONICS, LLC, Itasca, IL (US)

(21) Appl. No.: 13/658,337

(22) Filed: Oct. 23, 2012

Related U.S. Application Data
(60) Provisional application No. 61/551,078, filed on Oct. 25, 2011.

(51) Int. Cl. H04R 1/08

(52) U.S. Cl. CPC H04R 1/08
USPC 381/369

(57) ABSTRACT

A microphone module includes an outer housing and a microphone apparatus. The outer housing includes port that extends through the outer housing. The microphone apparatus is disposed in the outer housing and defines an extended back volume with the outer housing. The microphone apparatus includes a microphone apparatus housing, an acoustic sensing element, a front volume, and a back volume. The acoustic sensing element is disposed within the microphone apparatus housing. An opening in the microphone apparatus housing allows the extended back volume to communicate with the back volume.

### CROSS REFERENCE TO RELATED APPLICATIONS

This patent claims benefit under 35 U.S.C. §119(e) to U.S. Provisional Application No. 61/551,078 entitled “Vented Microphone Module” filed Oct. 25, 2011, the content of which is incorporated herein by reference in its entirety.

### TECHNICAL FIELD

This application relates to acoustic devices and, more specifically, to improving the operational characteristics and or dimensioning of these devices.

### BACKGROUND OF THE INVENTION

Various types of microphones and receivers have been used through the years. In these devices, different electrical components are housed together within a housing or assembly. For example, a microphone typically includes an acoustic sensing element consisting of an electret or a micro-electromechanical system (MEMS) device and a diaphragm, integrated circuits, among other components and these components are housed within the housing. Other types of acoustic devices may include other types of components. These devices may be used in hearing instruments such as hearing aids or in other electronic devices such as cellular phones and computers.

Microphones and receivers are typically disposed in other devices, for example, personal computers, cellular phones, and hearing instruments. The microphones may be placed in a module, which is disposed within these devices. To take one particular example, two microphones can be disposed in module and the module is disposed in a hearing instrument. The microphones often have to be configured to be of a particular size in order to be effective. More specifically, when disposed in the hearing instrument, the instrument housing often has to be of particular dimensions in order to hold the microphones.

The size of different devices where the microphones and receivers are disposed is constantly being reduced. For instance, there is almost constant consumer demand for smaller, reduced-weight, sleeker, and/or less cumbersome hearing instruments, cellular phones, and personal computers. However, in previous approaches the size of the microphone can only be reduced to certain dimensions. If the microphone were reduced below these dimensions its performance would be degraded. Thus, the various devices mentioned above can only be reduced to a certain size since the acoustic instrument can only be reduced to a certain size. This has resulted in dissatisfaction with previous approaches.

### BRIEF DESCRIPTION OF THE DRAWINGS

For a more complete understanding of the disclosure, reference should be made to the following detailed description and accompanying drawings wherein:

FIG. 1 is a block diagram of a device that uses an acoustic path according to various embodiments of the present invention;

FIGS. 2A and B are side cutaway views of a module with two microphones according to various embodiments of the present invention;

FIGS. 3A, B, and C are side cut-away views of a module with two microphones that uses a bracket to support the external rear volume according to various embodiments of the present invention;

FIG. 4A is a graph showing the sensitivity response of the devices described herein according to various embodiments of the present invention;

FIG. 4B is a graph showing the input-referred noise of the devices described herein according to various embodiments of the present invention.

Skilled artisans will appreciate that elements in the figures are illustrated for simplicity and clarity. It will further be appreciated that certain actions and/or steps may be described or depicted in a particular order of occurrence while those skilled in the art will understand that such specificity with respect to sequence is not actually required. It will also be understood that the terms and expressions used herein have the ordinary meaning as is accorded to such terms and expressions with respect to their corresponding respective areas of inquiry and study except where specific meanings have otherwise been set forth herein.

### DETAILED DESCRIPTION

In previous approaches, a microphone consists of a single housing in which all the components, including the acoustic sensing element and the front and rear (back) volumes are contained. In these previous approaches, this single housing may not fit in a hearing aid. In contrast and in the approaches described herein, otherwise unoccupied space in acoustic instrument devices, modules, assemblies, and/or hearing instrument housings is utilized to increase the rear volume of microphones. By utilizing otherwise un-utilized space the overall size of the microphone housing can be decreased. At the same time, the increased rear volume improves at least some of the operation characteristics of the microphone (e.g., its sensitivity) or, at the least, maintains the operational characteristics to be within acceptable limits.

In many of these embodiments, a microphone module includes an outer housing and a microphone apparatus. The outer housing includes port that extends through the outer housing. The microphone apparatus is disposed in the outer housing and defines an extended back volume with the outer housing. The microphone apparatus includes a microphone apparatus housing, an acoustic sensing element, a front volume, and a back volume. The acoustic sensing element is disposed within the microphone apparatus housing. The front volume communicates with the port of the microphone module and is defined by a first side of the acoustic sensing element and the microphone apparatus housing. The back volume is defined by a second side of the acoustic sensing element and the microphone apparatus housing. An opening in the microphone apparatus housing allows the extended back volume to communicate with the back volume.

In other aspects, the acoustic sensing element includes a diaphragm and a charged plate. In still other aspects, the rear volume and the extended volume are acoustically isolated from the port. In yet other aspects, the opening of the microphone apparatus extends across the entirety of the back volume.

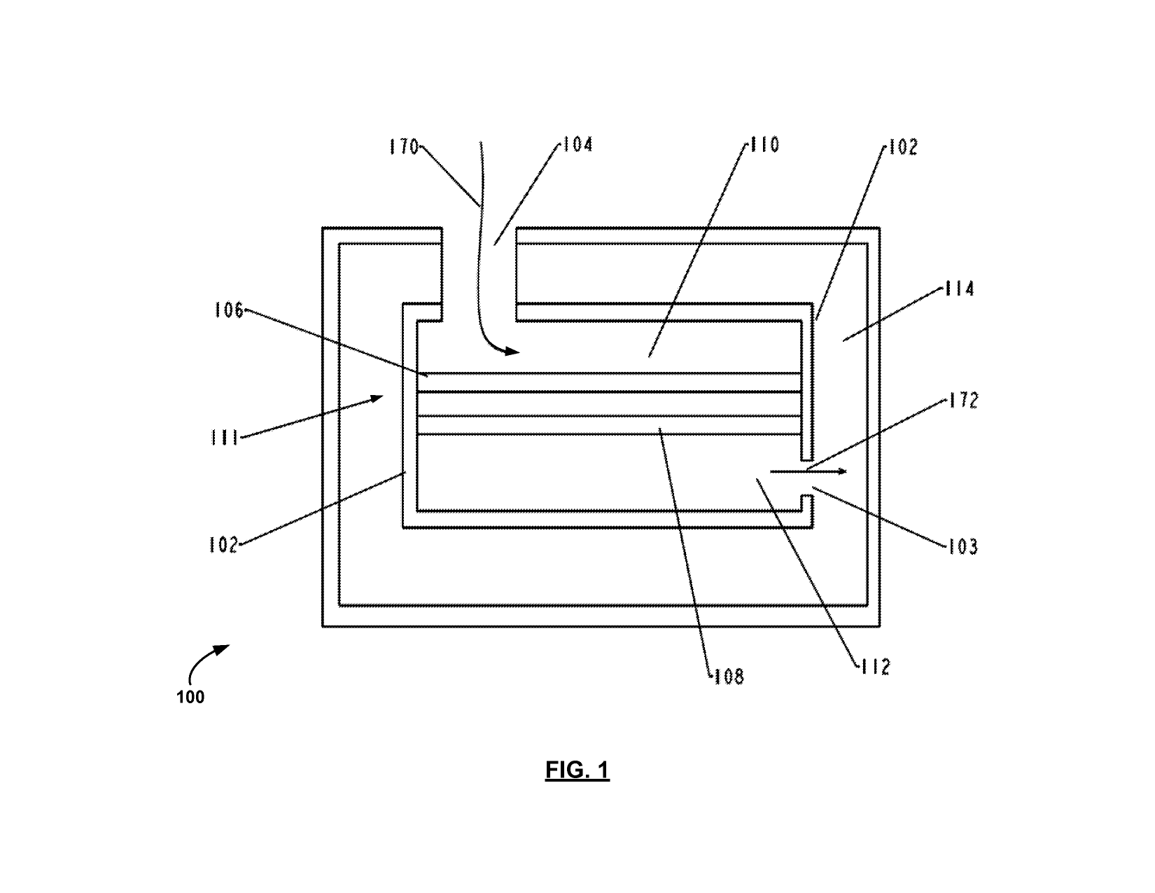

Referring now to FIG. 1, one example of a system that utilizes unoccupied space to increase the rear volume of at least one microphone is described. A microphone module 100 includes a microphone 102. The microphone 102 includes a housing 101, a sound port 104, an acoustic sensing element 111 including a diaphragm 106, and charge plate 108, a front volume 110, and a rear volume 112. The rear volume communicates with a extended rear volume 114 through an opening 103. The extended rear volume 114 is formed and defined by the housing of the module 100, the disposition of the microphone 102, and/or internal components of the module 100.

In operation, air flow (indicated by the arrow labeled 170) enters the microphone via the first port 104 into the first front volume 110. This airflow 170 moves the diaphragm 106, which creates a varying voltage across the sensing element 111 that is representative of the sound.

Air flow also moves between the first rear volume and the first extended rear volume. Consequently, the rear volume is not limited to the rear volume with the housing. In that respect, it is increased by use of the extended rear volume. Because the rear volume has been increased by using what was unutilized space, the microphone 102 has improved operational characteristics such as sensitivity. In other aspects, the rear volume 112 can be decreased and replaced with the extended rear volume 114.

In one aspect, the microphones described herein require that the rear volume of the microphone and the volume into which the rear volume is vented (i.e., the extended volume) are acoustically isolated from the sound port of the microphone (external to the microphone). This acoustic isolation may be accomplished by sealing the extended volume from the outside world. In contrast, previous vented microphones (e.g. microphones with barometric relief and/or directional microphones) utilize or otherwise require a return path from the rear volume to the sound port (via a path that is external to the microphone).

In one aspect, the housing of the microphone that resides in another module is opened to allow the rear volume to communicate with the extended rear volume. In other words, the opening 103 is not needed and the housing 101 opens to expose the inner components of the microphone.

In another advantage of the present approaches, the microphone module 100 can be narrower, less in height, less in length, weighs less, and/or is of otherwise smaller dimensions. In other words, the rear volume within the microphone housing within the module 100 can be custom-dimensioned to be smaller because the extended rear volume can be utilized. Thus, the microphone module 100 can be of smaller dimensions than would otherwise be possible.

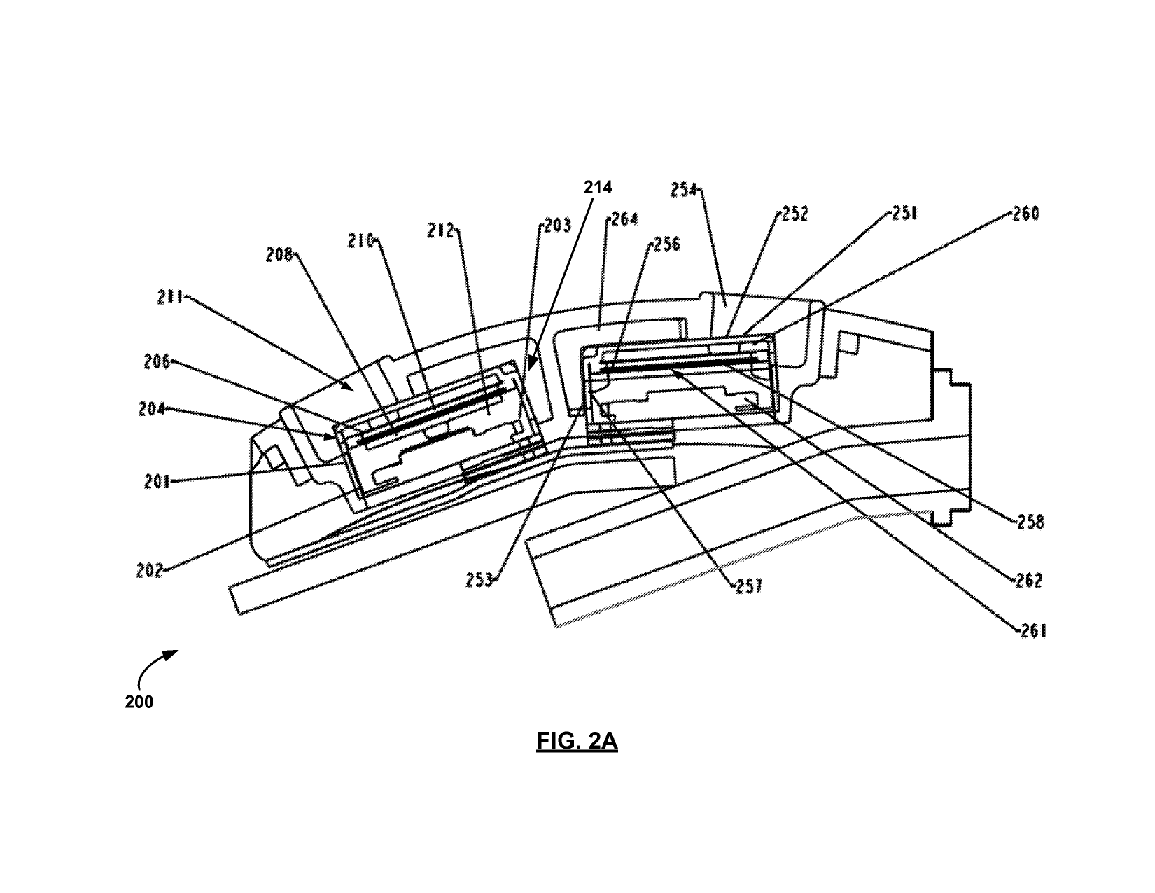

Referring now to FIGS. 2A and B, another example of a system that uses unutilized space to increase the rear volume is described. A microphone module 200 includes a first microphone 202 and a second microphone 252. The first microphone 202 includes a first housing 201, a first sound port 204, a first acoustic sensing element 211 that includes a first diaphragm 206 and a first charge plate 208, a first front volume 210, and a first rear volume 212. The first rear volume communicates with a first extended rear volume 214 through an opening 203. The second microphone 252 includes a second housing 251, a second sound port 254, a second acoustic sensing element 261 that include a second diaphragm 256 and a second charge plate 258, a second front volume 260, and a second rear volume 262. The second rear volume communicates with a second extended rear volume 264 through an opening 253. It will be appreciated that although two microphones are shown, that any number of microphones may be used. The extended rear volumes are formed and defined by the housing of the module 200, the disposition of the microphones within the module, and/or internal components of the module.

In operation, air flow (indicated by the arrow labeled 270) enters the first microphone via the first port 204 into the first front volume 210. This airflow 270 moves the first diaphragm 206, which creates a varying voltage across the acoustic sensing element 211 (or 261) that is representative of the sound.

Air flow 272 also moves between the first rear volume and the first extended rear volume. Consequently, the rear volume is not limited to the rear volume within the housing. In that respect, it is increased by use of the extended rear volume. Because the rear volume has been increased by using what was unutilized space within the module 200, the microphone has improved operational characteristics such as sensitivity.

In one aspect, the housing is opened to allow the rear volume to communicate with the extended rear volume. In other words, the openings 203 and 253 are not needed and the housings 201 and 251 open to expose the inner components of the microphone.

In another advantage of the present approaches, the microphone module 200 can be narrower, less in height, or of otherwise smaller dimensions. In other words, the rear volume of the individual microphone within the module 200 can be custom-dimensioned to be smaller because the extended rear volume can be utilized. Thus, the microphone module 200 can be of smaller dimensions than would otherwise be possible.

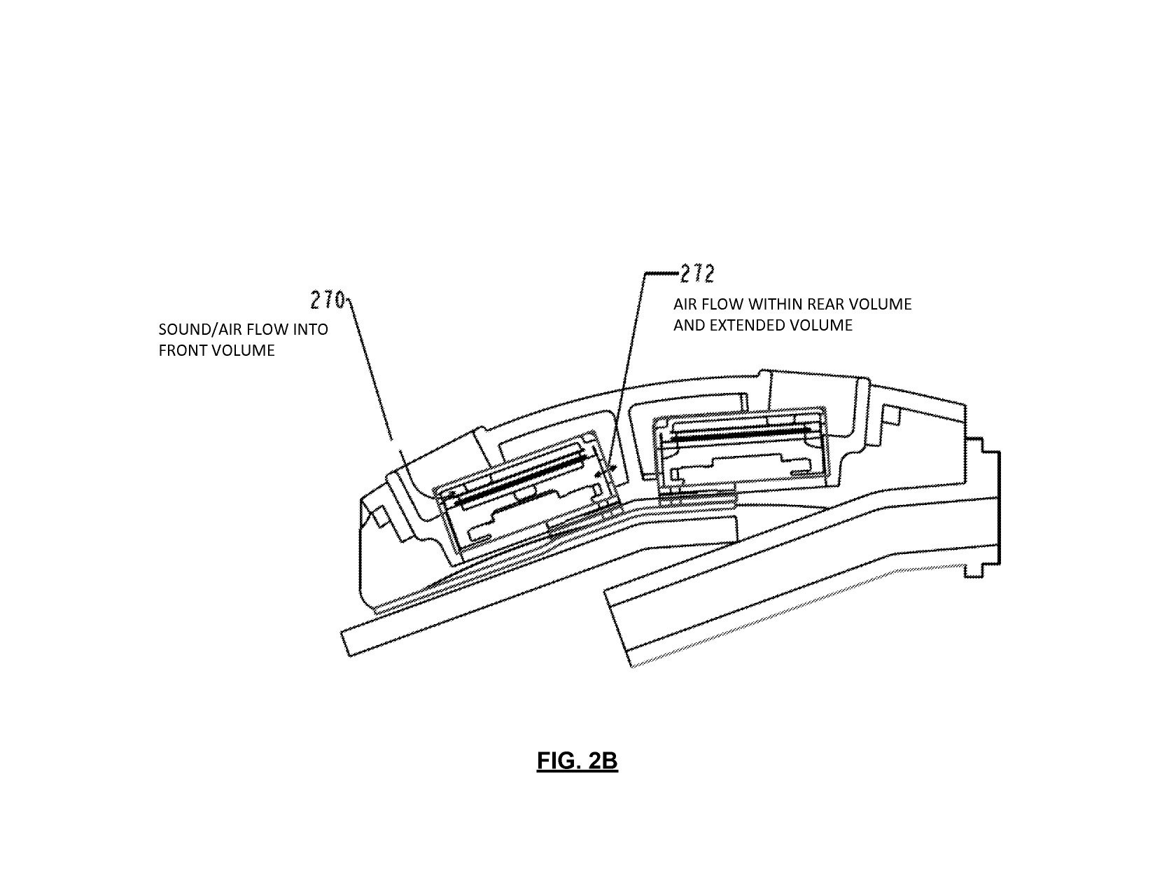

Referring now to FIGS. 3A, B, and C, another example of a system that utilizes wasted space to increase the rear volume is described. A microphone module 300 includes a microphone 302. The microphone 302 includes a housing 301, a sound port 304, an acoustic sensing element 311 including a diaphragm 306 and a charge plate 308, a front volume 310, and a rear volume 312. The rear volume communicates with a extended rear volume 314 through an opening 303. A second microphone is also shown in FIGS. 3A, B, and C. However, this second microphone—which is identical or similar to the microphone 302—is not labeled for simplicity.

In operation, air flow (indicated by the arrow labeled 370) enters the microphone via the first port 304 into the first front volume 310. This airflow moves the diaphragm 306, which creates a varying voltage across the acoustic sensing element 311 that is representative of the sound.

A bracket or brace 320 is used to hold the microphone in place and/or support the rear volume compartment. A second bracket 322 supports a second extended volume of a second microphone 326. It will be appreciated that the second microphone is constructed in a similar or identical manner to the first microphone. It will also be appreciated that the first microphone and the second microphone operate in a manner that is similar to the manner of the microphones described with respect to FIG. 1 and FIGS. 2A and B and this will not be described again here.

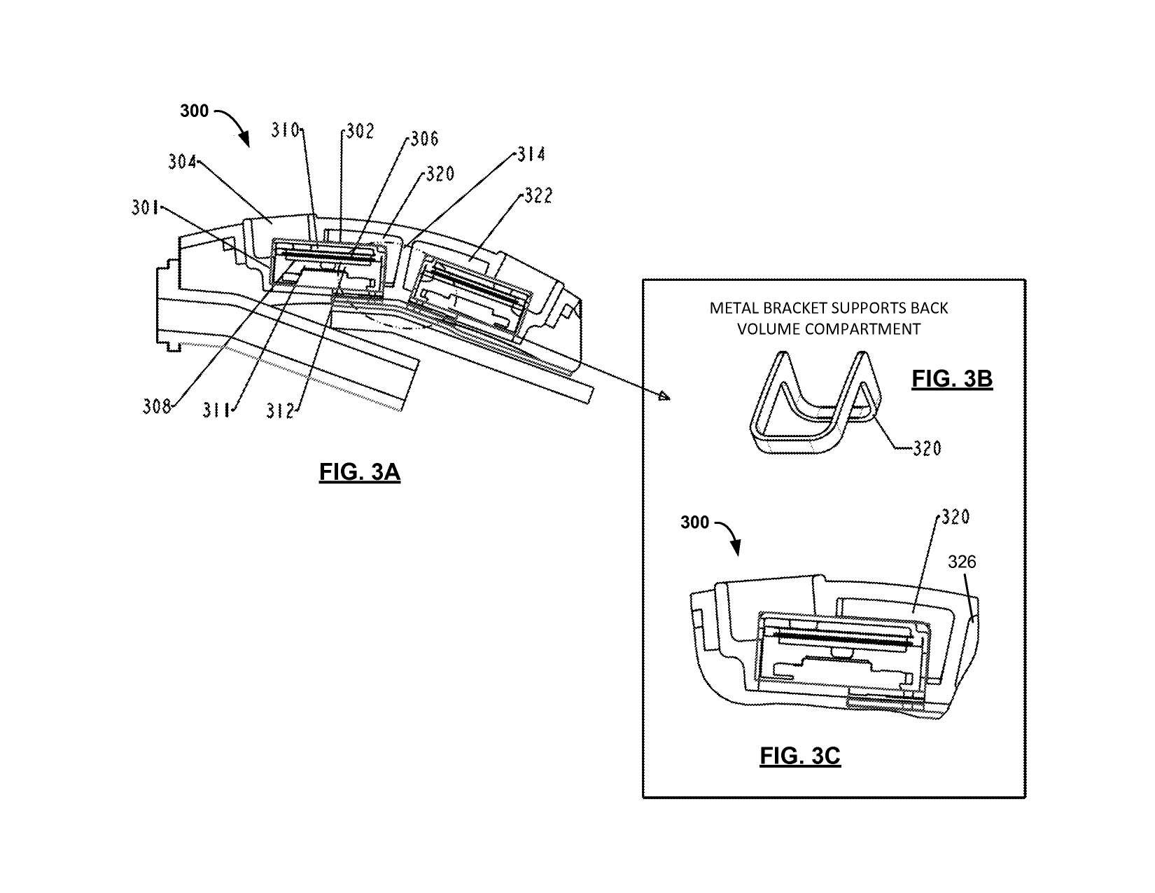

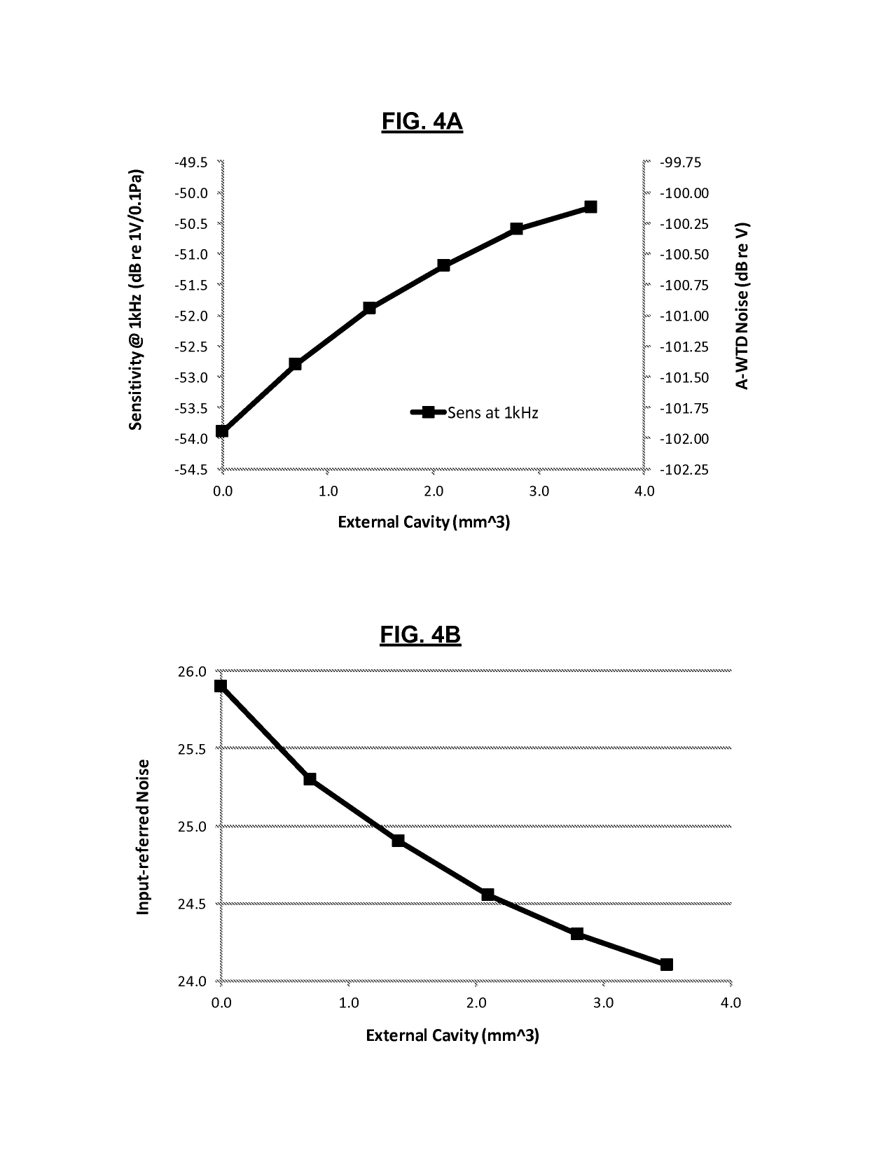

Referring now to FIG. 4A, a graph showing the sensitivity response of the devices described herein is described. It can be seen that as the volume of the external volume (extended rear volume) increases, the sensitivity increases.

Referring now to FIG. 4B, a graph showing the input-referred noise of the devices described herein is described. It can be seen that as the volume of the external volume (extended rear volume) increases, the input-referred noise decreases.

Preferred embodiments of this invention are described herein, including the best mode known to the inventors for carrying out the invention. It should be understood that the illustrated embodiments are exemplary only, and should not be taken as limiting the scope of the invention.

What is claimed is:

1. A microphone module, comprising:
an outer housing and a port extending through the outer housing;
a microphone apparatus, the microphone apparatus disposed in the outer housing and defining an extended back volume with the outer housing, the microphone apparatus comprising:
a microphone apparatus housing;
an acoustic sensing element disposed within the microphone apparatus housing;
a front volume communicating with the port of the microphone module, the front volume being defined by a first side of the acoustic sensing element and the microphone apparatus housing;
a back volume defined by a second side of the acoustic sensing element and the microphone apparatus housing;
an opening in the microphone apparatus housing, the opening allowing the extended back volume to communicate with the back volume.

2. The microphone module of claim 1 wherein the acoustic sensing element comprises a diaphragm and a charged plate.

3. The microphone module of claim 1 wherein the rear volume and the extended volume are acoustically isolated from the port.

4. The microphone module of claim 1 wherein the opening of the microphone apparatus extends across the entirety of the back volume.
